(19) United States
(12) Patent Application Publication
(10) Pub. No.: US 2019/0351843 A1
(43) Pub. Date: Nov. 21, 2019

(54) STRUCTURE AND METHOD FOR APPLYING AESTHETIC COVERINGS FOR VEHICLE INTERIOR COMPONENTS

(71) Applicant: Calsonic Kansei North America, Inc., Farmington Hills, MI (US)

(72) Inventor: Brian Bober, Farmington Hills, MI (US)

(21) Appl. No.: 15/980,020

(22) Filed: May 15, 2018

(51) Int. Cl. B60R 13/02; B62D 65/14

(52) U.S. Cl. CPC B60R 13/0206; B62D 65/14

(57) ABSTRACT

A skin attachment assembly comprises a skin that comprises a seam line and a retaining structure for locating and retaining the skin. The retaining structure comprises a bracket structure configured to locate the seam line of the skin to the substrate and a substrate defining a groove and comprising an attachment member positioned within a center portion of the groove. The bracket structure comprises a flange and a locating member. The flange is configured to be fixed to the seam line of the skin. The locating member of the bracket structure is configured to attach to the attachment member within the groove of the substrate.

### FIELD

The present application relates generally to the field of aesthetic coverings (e.g., leather, vinyl, fabric, etc., which may be referred to herein as “skins”) that are used in vehicle interior applications. More specifically, the present application relates to improved structures and methods for affixing aesthetic coverings onto rigid components intended for vehicle interior use.

### BACKGROUND

Typically, aesthetic coverings for use in vehicle interior applications are provided as loose skins that are wrapped around or otherwise fixed to a substrate, which is typically a more rigid member such as a hard polymeric material. An intervening cushion (e.g., a foam) may be provided between the skin and substrate for things such as armrests, center consoles, instrument panels, and the like. The covering or “skin” is loose relative to the substrate and the skin is set or located to the substrate with a visual estimation that requires the operator to use a separate fixture or jig to hold the skin in place relative to the substrate such that the skin and the substrate can be then bonded or wrapped into their final form. It would be advantageous to provide an improved structure and method for affixing the skin to the substrate.

### SUMMARY

An exemplary embodiment relates to a skin attachment assembly that comprises a skin that comprises a seam line and a retaining structure for locating and retaining the skin. The retaining structure comprises a bracket structure configured to locate the seam line of the skin to the substrate and a substrate defining a groove and comprising an attachment member positioned within a center portion of the groove. The bracket structure comprises a flange and a locating member. The flange is configured to be fixed to the seam line of the skin. The locating member of the bracket structure is configured to attach to the attachment member within the groove of the substrate.

Another exemplary embodiment relates to a method of locating and retaining a skin. The method comprises fixing a seam line of a skin to a flange of a bracket structure, locating the seam line of the skin to a groove defined by a substrate with a locating member of the bracket structure, and attaching the locating member of the bracket structure to an attachment member positioned within a center portion of the groove of the substrate.

### BRIEF DESCRIPTION OF THE DRAWINGS

FIG. 1 is a schematic view of a skin attachment assembly according to various embodiments.

FIG. 2 is a top view of a skin and a thread of the skin attachment assembly of FIG. 1.

FIG. 3 is a top view of a bracket structure of the skin attachment assembly of FIG. 1.

FIG. 4 is a cross-sectional view of a bracket structure through Section A-A of FIG. 3 according to one embodiment.

FIG. 5 is a perspective view of the bracket structure of FIG. 4.

FIG. 6 is a cross-sectional view of a bracket structure through Section A-A of FIG. 3 according to another embodiment.

FIG. 7 is a cross-sectional view of a bracket structure through Section A-A of FIG. 3 according to another embodiment.

FIG. 8 is a perspective view of the bracket structure of FIG. 7.

FIG. 9 is a cross-sectional view of a bracket structure through Section A-A of FIG. 3 according to yet another embodiment.

FIG. 10 is a perspective view of the bracket structure of FIG. 9.

FIG. 11 is a cross-sectional view of a bracket structure through Section A-A of FIG. 3 according to another embodiment.

FIG. 12 is a perspective view of the bracket structure of FIG. 11.

FIG. 13 is a top view of the skin and the bracket structure of the skin attachment assembly of FIG. 1 attached to each other.

FIG. 14 is a cross-sectional view of a skin and the bracket structure of FIG. 7 attached to each other through Section B-B of FIG. 13.

FIG. 15 is a cross-sectional view of a skin and the bracket structure of FIG. 6 attached to each other through Section B-B of FIG. 13.

FIG. 16 is a cross-sectional view of a skin and the bracket structure of FIG. 11 attached to each other through Section B-B of FIG. 13.

FIG. 17 is a top view of the substrate of the skin attachment assembly of FIG. 1.

FIG. 18 is a cross-sectional view of a substrate through Section C-C of FIG. 17 according to one embodiment.

FIG. 19 is a cross-sectional view of a substrate through Section C-C of FIG. 17 according to another embodiment.

FIG. 20 is a perspective view of the substrate of FIG. 19.

FIG. 21 is a cross-sectional view of a substrate through Section C-C of FIG. 17 according to yet another embodiment.

FIG. 22 is a perspective view of the substrate of FIG. 21.

FIG. 23 is a cross-sectional view of a substrate through Section C-C of FIG. 17 according to still another embodiment.

FIG. 24 is a perspective view of the substrate of FIG. 23.

FIG. 25 is a cross-sectional view of a substrate through Section C-C of FIG. 17 according to another embodiment.

FIG. 26 is a perspective view of the substrate of FIG. 25.

FIG. 27 is a top view of the skin attached to the bracket structure being located to the substrate of the skin attachment assembly of FIG. 1.

FIG. 28 is a perspective view of the skin and bracket structure of FIG. 14 being located to the substrate of FIG. 21 along View E-E of FIG. 27.

FIG. 29 is a perspective view of the skin and bracket structure of FIG. 15 being located to a substrate according to one embodiment along View E-E of FIG. 27.

FIG. 30 is a top view of the skin attachment assembly of FIG. 1.

FIG. 31 is a cross-sectional view of a skin attachment assembly through Section D-D of FIG. 30 according to one embodiment.

FIG. 32 is a cross-sectional view of a skin attachment assembly through Section D-D of FIG. 30 according to another embodiment.

FIG. 33 is a cross-sectional view of a skin attachment assembly through Section D-D of FIG. 30 according to yet another embodiment.

FIG. 34 is a cross-sectional view of a skin attachment assembly through Section D-D of FIG. 30 according to still another embodiment.

FIG. 35 is a cross-sectional view of a skin attachment assembly through Section D-D of FIG. 30 according to another embodiment.

FIG. 36 is a flow diagram of a method of locating and retaining a skin according to one embodiment.

FIG. 37 is a perspective view within a vehicle with a center console according to one embodiment.

### DETAILED DESCRIPTION

Referring to the figures generally, the various embodiments disclosed herein relate to a skin attachment assembly and method that locates and retains a seam line of a skin to a substrate. The skin may be located and retained to the substrate prior to, for example, permanently bonding or wrapping the skin and the substrate into their final shape or form. It should be noted that the term “skin” as used herein may refer to any type of flexible material that may be used in the passenger-facing surfaces within a vehicle compartment, such as but not limited to leather, vinyl, fabric, and the like.

Prior to locating and retaining the skin to the substrate, the skin is loose relative to the substrate. By using the retaining structure, the skin and the substrate can be more easily and quickly located and retained in place relative to each other and subsequently permanently bonded or wrapped, eliminating the need for and no longer requiring the operator to use locating fixtures or jigs, which effectively speeds up the assembly process.

In conventional skin wrapping assemblies, the skin does not include any molded-in or natural locating and retaining features, which prevents the skin from being easily located and retained to the substrate. Conversely, as described further herein, the present retaining structure allows the skin to be easily located and retained to a substrate by providing locating and retaining features.

Due to the configuration of the skin attachment assembly, the number of functional sewing steps is minimized and decorative stitches are not required to hold the skin in place relative to the substrate (although decorative stitches may optionally be added for aesthetics). For example, the skin can be held in place relative to and attached to the substrate with only one line of functional stitching or one seam line, instead of, for example, three lines of stitching as may be used in conventional skin wrapping assemblies. However, it is understood that the skin attachment assembly may optionally include decorative lines of stitching. Furthermore, the configuration of the skin attachment assembly allows the seam line of the skin to be relatively straight instead of wavy.

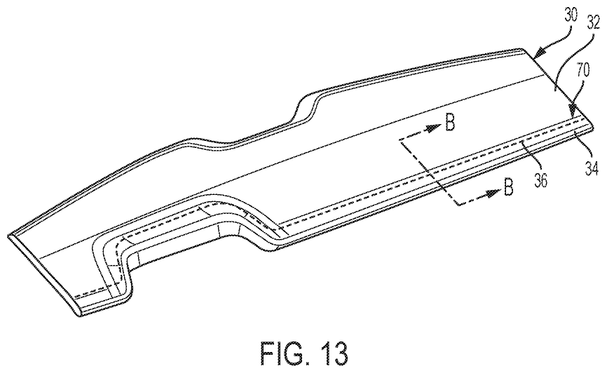

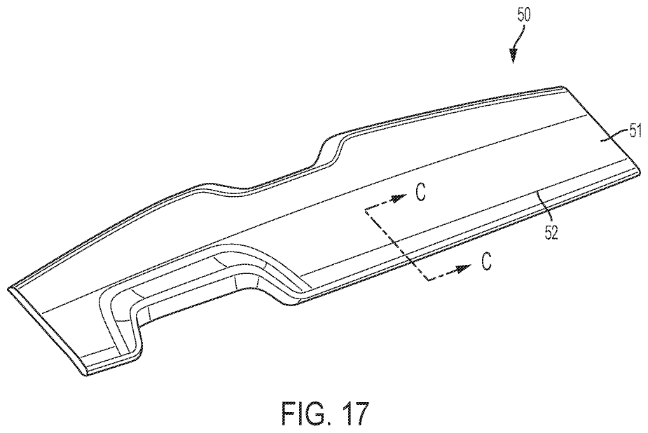

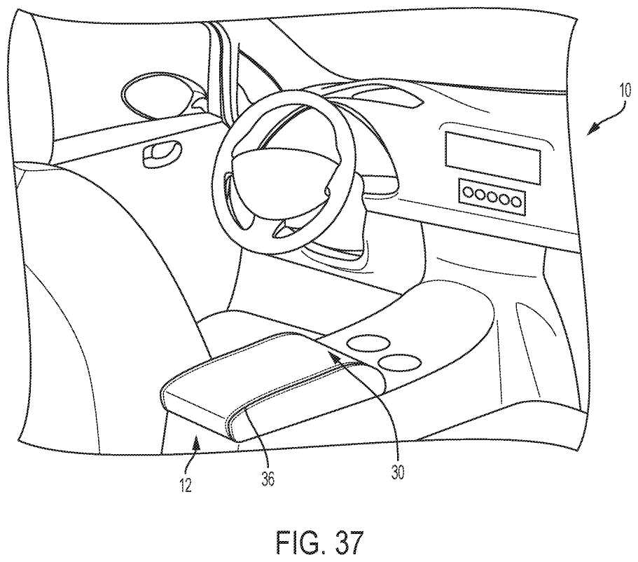

As shown in FIG. 37, a center console 12 is positioned within a vehicle 10 to provide support and/or a storage area for the user. The center console 12 is covered with a skin 30 that is visible within the vehicle 10. Alternatively, an instrument panel may be covered with the skin 30, as shown in FIGS. 13 and 17. The skin 30 includes a seam line 36 that extends along at least a portion of the skin 30.

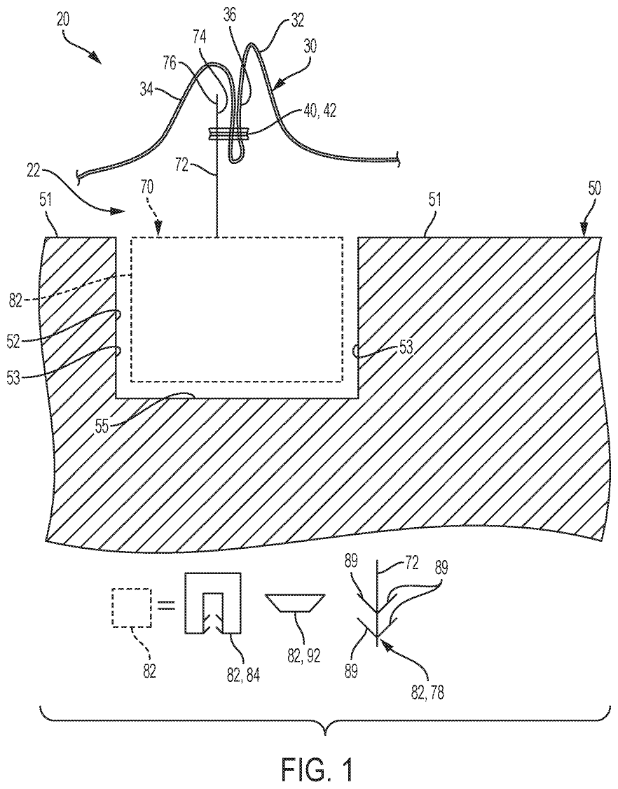

In order to attach the skin 30 (specifically the seam line 36) to a substrate 50 of the console or of the instrument panel, a skin attachment assembly 20 is used. As shown in FIG. 1, the skin attachment assembly 20 includes the skin 30, thread 40, and a retaining structure 22. The retaining structure 22 is configured to both locate and retain the skin 30 and comprises a substrate 50 and a bracket structure 70, as described further herein.

As shown in FIG. 1, the skin 30 is configured to substantially cover or conceal (e.g., wrap around) the substrate 50 and is therefore aligned with the substrate 50 to properly cover the substrate 50. Accordingly, the retaining structure 22 is configured to align and attach the skin 30 to the substrate 50, as described further herein.

The skin 30 comprises a seam line 36 (e.g., a bite line, fold, feature line, etc.) along which two skin portions are attached to or folded onto each other. The skin 30 is configured to be stitched along the seam line 36 (e.g., to the flange 72, as described further herein) to maintain the seam line 36 together. As shown in FIGS. 1-2 and 13, the skin 30 comprises a first skin part or portion 32 on one side of the seam line 36 and a second skin part or portion 34 of the other side of the seam line 36. According to one embodiment, the first skin portion 32 is a first skin and the second skin portion 34 is a second skin, where the first skin and the second skin are two separate pieces of material that are attached or fixed to each other along the seam line 36 with the stitch line 42 to form a larger skin assembly. The two separate pieces of material overlap each other along the seam line 36. According to another embodiment, the first skin portion 32 and the second skin portion 34 are a part of and formed from one single, continuous piece or sheet of material that is folded on itself along the seam line 36. Accordingly, the seam line 36 defines the first skin portion 32 and the second skin portion 34 and divides the skin 30 into the two parts (i.e., the first skin portion 32 and the second skin portion 34).

The skin 30 can be constructed out of a variety of different materials, including but not limited to fabric, leather, vinyl, cloth, or another polymeric material such as a thermoplastic olefin (TPO) or thermoplastic urethane (TPU).

A functional thread 40 is stitched or sewn to the skin 30 to create the seam line 36, which, at the same time, attaches or sews the seam line 36 to the bracket structure 70 (as described further herein). The thread 40 is formed or sewn into a functional seam or stitch line 42 (rather than purely ornamental stitch line) when attached or stitched to the skin 30 (along the seam line 36) and the bracket structure 70. As described further herein, the stitch line 42 (and therefore the thread 40) holds and attaches the skin 30 and the bracket structure 70 together.

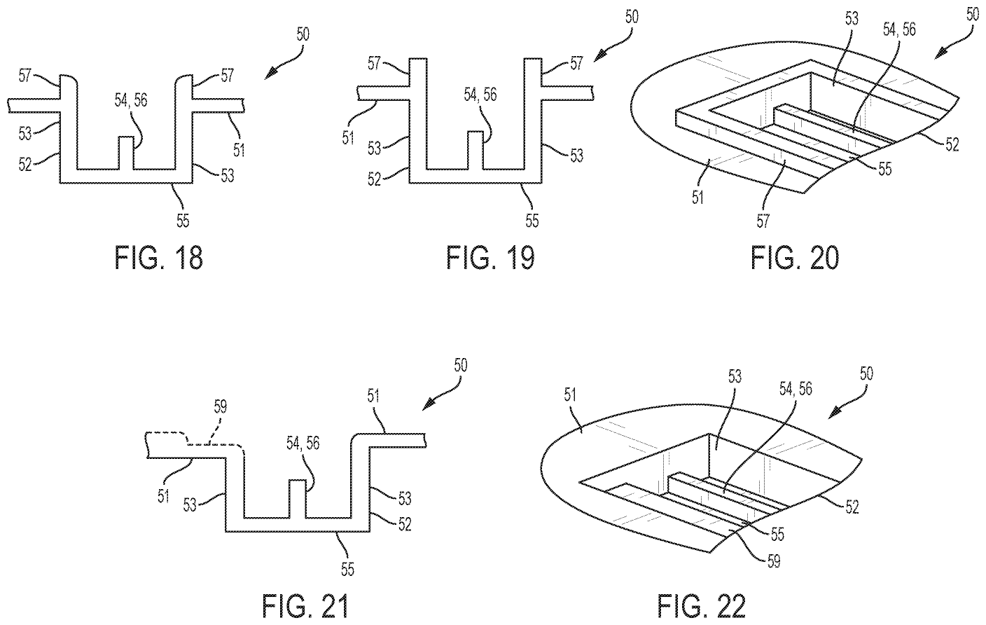

As shown in FIG. 1, the locating and retaining structure 22 is configured to locate the seam line 36 of the skin 30 and attach and retain the skin 30 to the substrate 50 in a particular position. Accordingly, the retaining structure 22 comprises the bracket structure 70 and the substrate 50. The bracket structure 70 includes a flange 72 that attaches to the skin 30 and a locating member 82 that attaches to the substrate 50, as described further herein. The substrate 50 includes a groove 52 that receives the locating member 82 of the bracket structure 70 and an attachment member 54 (as shown in FIGS. 18-26, for example) that secures the bracket structure 70 within the groove 52, as also described further herein. The substrate 50 may optionally further comprise a recess 59 (as shown in FIGS. 21-22 and 25-26, for example).

As shown in FIGS. 1 and 13-16, the clasp, locating strip, or bracket structure 70 is configured to engage, hold, or attach to the skin 30 along the seam line 36, locate the seam line 36 of the skin 30 to the groove 52 of the substrate 50, and engage with, grip onto, or attach with the attachment member 54 in the groove 52 of the substrate 50, which attaches and retains the skin 30 to the substrate 50. Accordingly, the bracket structure 70 (with the skin 30) is received and secured within the groove 52 of the substrate 50.

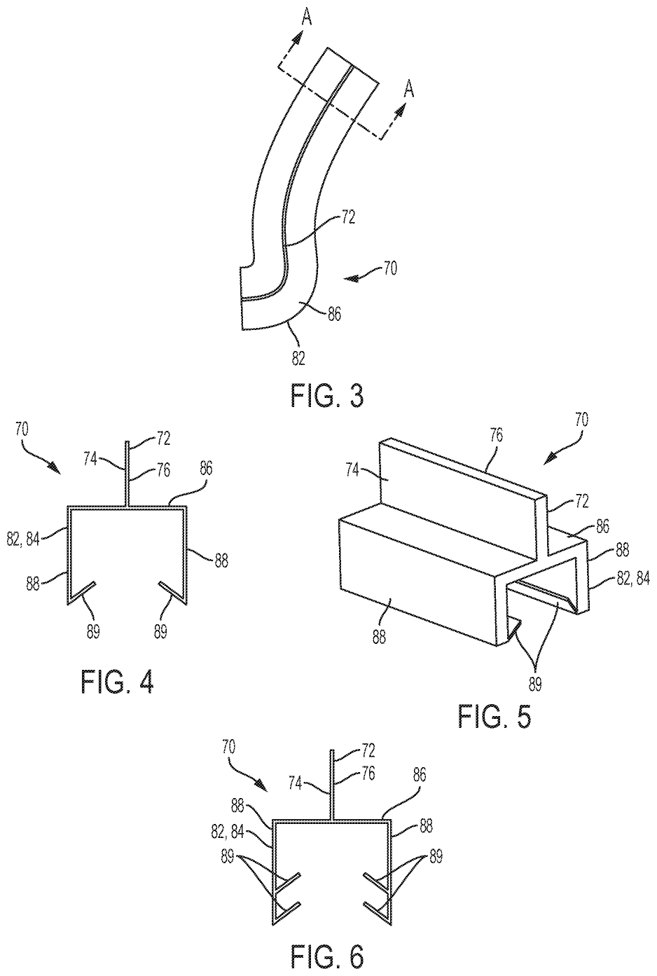

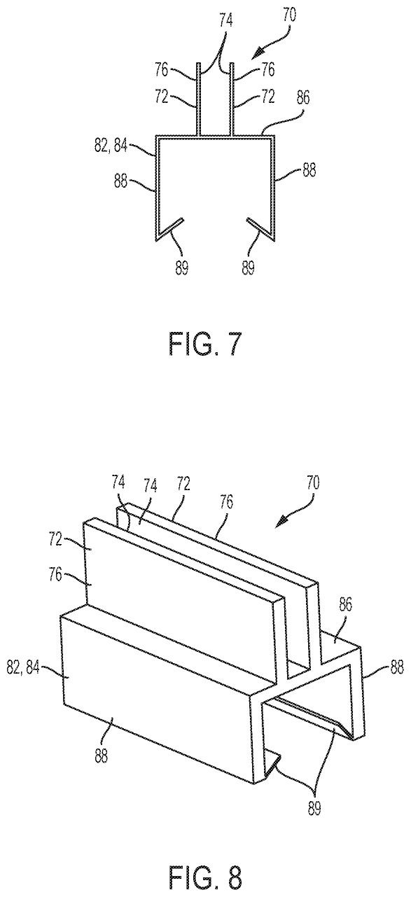

As shown in FIGS. 3-12 and 14-16, the bracket structure 70 comprises at least one upper flange 72 and a locating member 82. As shown in FIGS. 5 and 10, one end of the skin fixing member, vertical strip, extension, protrusion, raised tab, tongue, fin, or flange 72 is attached to or extends vertically from a top surface of the locating member 82. The flange 72 extends lengthwise along the length of the locating member 82. The bracket structure 70 can include any number of flanges 72. For example, as shown in FIGS. 4-6 and 9-10, the bracket structure 70 includes one flange 72. Alternatively, as shown in FIGS. 7-8 and 11-12, the bracket structure 70 includes two flanges 72 that are substantially parallel to each other (and each extend from the respective top wall of the locating member 82) with a small gap therebetween (for the skin 30 to be inserted into, as described further herein).

As shown in FIGS. 1 and 13-16, the flange 72 is configured to be fixed to the seam line 36 of the skin 30. More specifically, the flange 72 is sewn or stitched with the functional stitch line 42 to the skin 30 along the seam line 36 to couple or attach the skin 30 (and therefore the first skin portion 32 and the second skin portion 34) to the flange 72. The thread 40 that forms the seam line 36 on the skin 30 is stitched through both the first skin portion 32 and the second skin portion 34 of the skin 30 and through the flange 72 (or flanges 72), which thereby attaches the skin 30 to the flange 72 (or flanges 72) of the bracket structure 70.

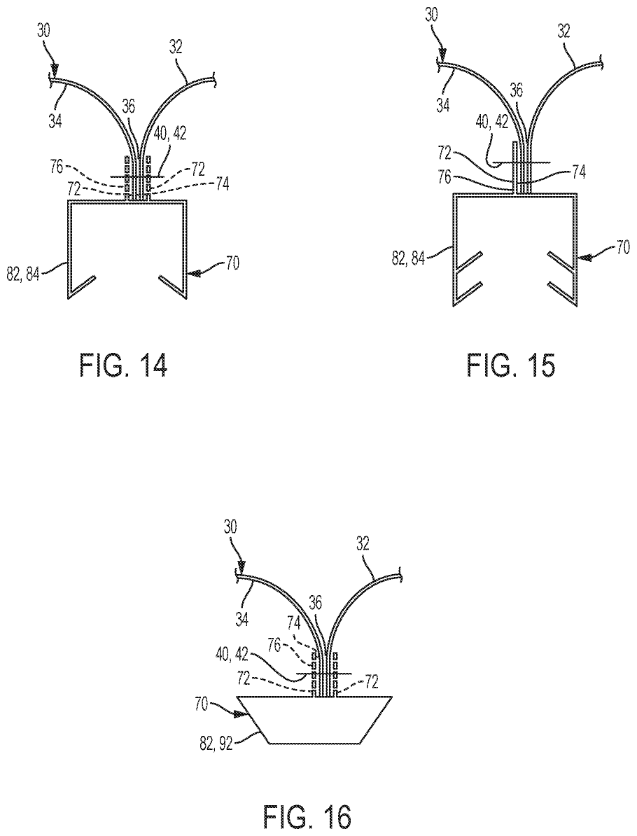

As shown in FIGS. 1 and 4-12, the flange 72 has a first side 74 and a second side 76. As shown in FIG. 1, the seam line 36 of the skin 30 is stitched or fixed to one side (i.e., the first side 74) of the flange 72. Accordingly, both the first skin portion 32 and the second skin portion 34 of the skin 30 are positioned along and attached to the same side (i.e., the first side 74) of the flange 72 (or of each of the flanges 72). Since the skin 30 is attached or coupled to the same side of the flange 72 (rather than opposite sides of the flange 72 or of each of the flanges 72), the flange 72 is (or flanges 72 are) completely concealed by the skin 30 and not visible along the seam line 36, regardless of how tight the skin 30 is pulled in the final assembly. However, it is understood that the first skin portion 32 and the second skin portion 34 can be positioned along either side of the flange 72 (e.g., on the right-hand side or the left-hand side). Furthermore, as shown in FIGS. 14 and 16, if the bracket structure 70 includes two flanges 72, the first skin portion 32 and the second skin portion 34 are positioned in a gap between the two flanges 72 such that the flanges 72 are positioned on either side of both the first skin portion 32 and the second skin portion 34 together.

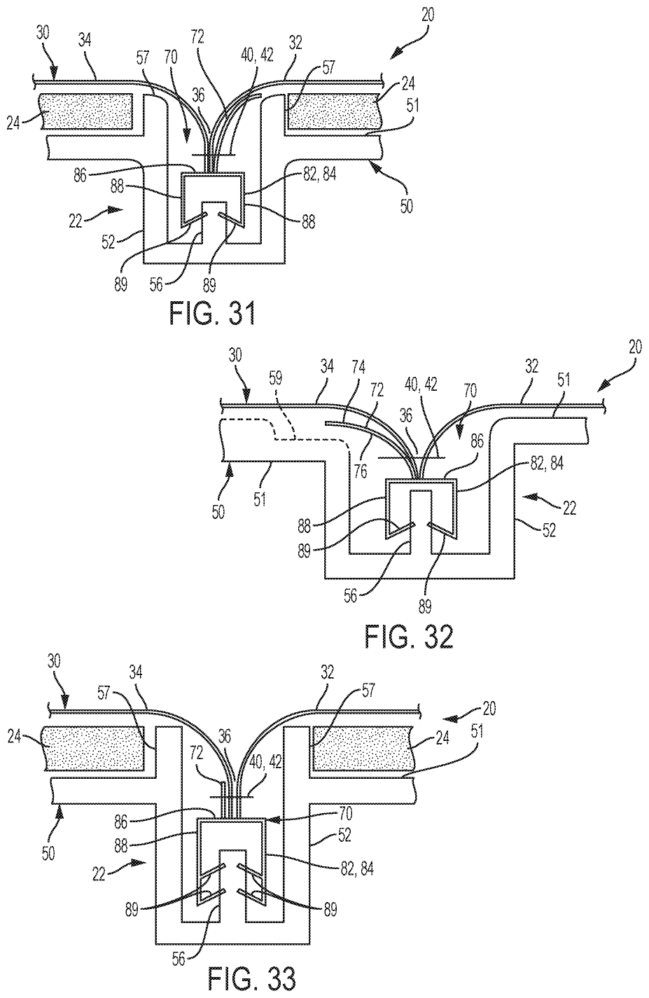

According to one embodiment as shown in FIGS. 31-32 and 34-35, the flange 72 is flexible to allow the flange 72 to fold and bend over. The flange 72 bends and curves with the bottom surface of the skin 30 to prevent the flange 72 from showing through the skin 30. The flange 72 may have a variety of different thicknesses, such as approximately 0.5 millimeters (mm), to be sufficiently flexible while providing sufficient strength to retain the attachment to the skin 30. Depending on the relative sizes of the various components within the skin attachment assembly 20 (e.g., the depth of the groove 52 (or the height of the side walls 53 of the groove 52), the height of the flange 72, the position of the flange 72 within the groove 52 (e.g., whether the attachment member 54 is an extension 56 or a slot 58, as described further herein), and the height of the extension 56), the flange 72 may extend over the top edge of the groove 52 or may be completely positioned within and encompassed by the groove 52 when attached to the attachment member 54.

According to one embodiment in which the substrate 50 defines a recess 59 along the top finished surface of the top wall 51 of the substrate 50 (as described further herein and shown in FIGS. 32 and 35), the flange 72 is configured to bend into and be received within the recess 59. The recess 59 is positioned along the side of the groove 52 that is closer to the second side 76 of the flange 72 than the first side 74 of the flange 72. Accordingly, the recess 59 is on an opposite side of the groove 52 than the first side 74 of the flange 72 onto which the skin 30 is positioned and attached. Since the skin 30 is attached or sewn to the first side 74 of the flange 72, the flange 72 is folded and bent over toward the second side 76 of the flange 72 (e.g., the side of the flange 72 that is opposite to the side of the flange 72 onto which the skin 30 is attached) into the recess 59. The flange 72 is bent and in-line with a lower surface of one part (e.g., the second skin portion 34) of the skin 30. The flange 72 is bent into and fits within the recess 59 of the substrate 50 such that the second side 76 of the flange 72 is flush or sub-flush with the top surface of the top wall 51 of the substrate 50. Accordingly, the flange 72 is thereby completely concealed and the final top surface of the skin attachment assembly 20 appears smooth and does not include any bumps or protrusions caused by material build up (e.g., by the flange 72 extending upwardly rather than bending over), as shown in FIGS. 32 and 35.

According to various embodiments, the flange 72 may not extend over the top edge of the groove 52 (and along the top wall 51 of the substrate 50) due to the relative sizes of various components within the skin attachment assembly 20 (e.g., the height of the side walls 53 of the groove 52, the height of the flange 72, and/or the presence of a rim 57 and spacer fabric 24). Accordingly, the height of the flange 72 may be less than the height of the groove 52 or less than the height of the side walls 53 of the groove 52 and the height of the rim 57. Accordingly, since the flange 72 is shorter than the groove 52 and does not clear the side walls 53 of the groove 52 (and optionally the rim 57), the flange 72 is not flexible since the flange 72 is already completely obstructed within the groove 52 and will not otherwise create a bump or protrusion along the final top surface of the skin attachment assembly 20.

As shown in FIGS. 1 and 4-12, the bracket structure 70 further comprises a bite or locating member 82 that is positioned along one end (i.e., the bottom end) of the flange 72. The locating member 82 is configured to engage with and attach to the attachment member 54 of the substrate 50 within the groove 52 of the substrate 50. Accordingly, the substrate 50 (specifically the attachment member 54) is configured to receive and retain the locating member 82 within the groove 52, as described further herein. According to one embodiment, the locating member 82 engages with at least one wall of the groove 52, such as an underside of the bottom wall 55 of the groove 52.

As shown in the figures and described further herein, the locating member 82 may have a variety of different configurations, shapes, and profiles (e.g., a clip 84, a plug 92, or a hook 78) according to the various embodiments and according to the configuration of the attachment member 54. As described further herein, the configuration of the locating member 82 and the attachment member 54 correspond to and are complementary to each other such that the locating member 82 and the attachment member 54 are attachable to each other. Additionally, the bracket structure 70 may have an extruded profile.

To attach the locating member 82 of the bracket structure 70 to the attachment member 54 of the substrate 50, the locating member 82 and the attachment member 54 attach similarly to a press seal of a Ziploc® bag. For example, the locating member 82 is positioned along the groove 52 (and along the attachment member 54) and then pressed straight into the groove 52, which interlocks the locating member 82 to the attachment member 54 within the groove 52. Depending on the specific configuration of the attachment member 54 of the substrate 50 and the locating member 82 of the bracket structure 70, the attachment member 54 and the locating member 82 can be attached and retained to each other in a variety of different ways and with a variety of different locking mechanisms. To attach to each other, the configurations of each of the locating member 82 and the attachment member 54 are complementary to each other.

According to one embodiment as shown in FIGS. 4-8, the locating member 82 is a bite-on clasp or clip 84 that comprises a top wall 86, two opposing flanges or side walls 88, and teeth 89. The top wall 86 extends between top ends of the side walls 88. The side walls 88 extend downwardly from a bottom surface of the top wall 86 (and the flange 72 extends upwardly from a top surface of the top wall 86). The top wall 86 and the side walls 88 together define a groove or channel, which creates a “fork-like” configuration of the clip 84. As shown in FIGS. 5 and 8, the top wall 86 and the side walls 88 extend along the length of the clip 84.

The teeth 89 are positioned or formed within the channel defined by the clip 84 along the side walls 88. The teeth 89 extend inwardly from an inner surface of each of the side walls 88 such that teeth 89 on opposite side walls 88 extend toward each other in a center region of the locating member 82. To grip the attachment member 54, the teeth 89 extend at an angle from the side walls 88 such that the teeth 89 point upwardly (e.g., toward the top wall 86 of the clip 84). The teeth 89 may be positioned toward a bottom end of the side walls 88 and may extend along the entire length of the side walls 88. The clip 84 may include one tooth 89 along each of the side walls 88 (as shown in FIGS. 4-5 and 7-8) or multiple teeth 89 along each of the side walls 88, where the teeth 89 on each of the side walls 88 are substantially parallel to each other (as shown in FIG. 6). For example, according to one embodiment, the clip 84 may include two teeth 89 on each of the side walls 88 that are parallel to each other and substantially the same size.

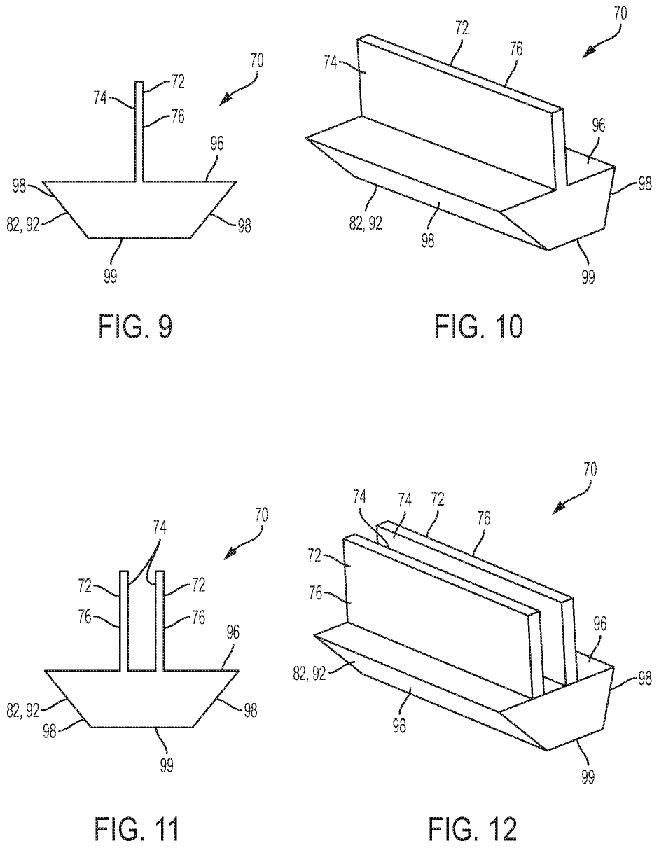

According to other embodiments as shown in FIGS. 9-12, the locating member 82 is a widened tip, pin, or plug 92. The plug 92 has a top wall 96, side walls 98, and a bottom wall 99 that are attached to each other along their ends. The flange 72 extends from a top surface of the top wall 96 of the plug 92. As shown in FIGS. 10 and 12, the top wall 96, the side walls 98, and the bottom wall 99 extend along the length of the plug 92.

According to one embodiment, the side walls 98 are tapered or angled downwardly toward each other and the top wall 96 and the bottom wall 99 are substantially parallel such that the plug 92 may have a trapezoidal cross-section. Accordingly, the top wall 96 is wider than the bottom wall 99. This trapezoidal shape allows the plug 92 to attach to the locating member 82 more easily.

It is understood that the locating member 82 may have a variety of different configurations and shapes and that the attachment member 54 may have a variety of different complementary configurations and shapes to provide an area for the locating member 82 to attach to. For example, according to an alternative embodiment as shown in FIG. 1, the locating member 82 may be a catch or hook 78. With the hook 78, the flange 72 may extend further downward and have teeth 89 that extend outwardly from a bottom portion of the flange 72. The teeth 89 engage with and attach to the attachment member 54, which may be, for example, the slot 58. The teeth 89 may be oriented to extend upwardly toward a top portion of the flange 72 and may be substantially parallel to each other to grip the sides of the slot 58 and/or the bottom surface of the bottom wall 55 of the groove 52, which attaches the hook 78 (and therefore the bracket structure 70) to the slot 58 (and thereby the substrate 50).

The base or substrate 50 may be a variety of different components, such as a component within a vehicle. For example, the substrate 50 may be a support structure within an armrest of a vehicle seat within a vehicle. As described further herein, the substrate 50 is at least partially covered or concealed by the skin 30 to provide a particular aesthetic or feel around or over at least a portion of the substrate 50. The substrate 50 defines a groove 52 and comprises an attachment member 54 that are each complementary to the locating member 82 of the bracket structure 70 to receive and secure the bracket structure 70.

As shown in FIGS. 1 and 18-26, the substrate 50 defines a ditch line, cavity, channel, or groove 52 that provides an area for the substrate 50 to receive the bracket structure 70 (and therefore also the seam line 36 of the skin 30, which is attached to the flange 72 of the bracket structure 70) to attach the bracket structure 70 to the substrate 30 and to retain the bracket structure 70 within the groove 52, which thus attaches and secures the skin 30 and the substrate 50 together. The groove 52 extends lengthwise along the top wall 51 of the substrate 50.

The groove 52 extends from the top wall 51 of the substrate 50 and is formed or defined by two opposing side walls 53 and a bottom wall 55. The side walls 53 extend downwardly from the top wall 51 of the substrate 50 and into the substrate 50. The bottom wall 55 extends between and connects the bottom portions of the side walls 53. According to one embodiment, the side walls 53 of the groove 52 are tapered or angled (relative to the top wall 51 of the substrate 50 and the bottom wall 55 of the groove 52) to allow the bracket structure 70 to be more easily inserted into the groove 52 and to be more securely attached in the bottom of the groove 52 (to the attachment member 54). Accordingly, the width at the top of the groove 52 is greater than the width at the bottom of the groove 52 according to one embodiment. According to another embodiment, the vertical height of the groove 52 (e.g., the distance between the top wall 51 of the substrate 50 and the bottom wall 55 of the groove 52) may cause the bracket structure 70 to bottom out during insertion to allow the operator to know that the bracket structure 70 has been fully inserted into the groove 52.

According to one embodiment (as shown in FIGS. 21-22 and 25-26), the top surface of the top wall 51 of the substrate 50 defines an indentation, a recessed portion, relief area, or recess 59 positioned and extending along at least one side of the groove 52 that provides an area for the flange 72 of the bracket structure 70 to bend, move into, and be received within (as shown in FIGS. 32 and 35). Accordingly, the recess 59 allows the flange 72 to be flush or sub-flush with the top surface of the top wall 51 of the substrate 50. In particular, the substrate 50 may include the recess 59 in hard-wrapped conditions in which the skin attachment assembly 20 does not include any foam layer or spacer fabric around the outside of the substrate 50. The recess 59 forms a step shape along the top surface of the top wall 51 of the substrate 50 and next to the upper area of one of the side walls 53 of the groove 52. The recess 59 can be positioned along either side of the groove 52. According to one embodiment, the recess 59 is positioned along only one side of the groove 52.

Due to the recess 59, the curvature of the substrate 50 between the top surface of the top wall 51 of the substrate 50 and one of the side walls 53 of the groove 52 is less along one side of the groove 52 (i.e., the side of the groove 52 that the recess 59 is positioned along) than a corresponding curvature along the other side of the groove 52 (i.e., the side of the groove 52 without the recess 59), which provides an area to receive the flange 72. Since the recess 59 is positioned closer to the second side 76 of the flange 72, the curvature of the substrate 50 is larger along the side of the groove 52 that is closest to the first side 74 of the flange 72 (where the skin 30 is positioned along and attached to the first side 74 of the flange 72), and the curvature of the substrate 50 is smaller along the side of the groove 52 that is further from the first side 74 of the flange 72 (and thereby closer to the second side 76 of the flange 72). Therefore, once the skin attachment assembly 20 is assembled, the flange 72 is bent over toward the second side 76 of the flange 72 and is received within the relatively smaller curvature (i.e., the recess 59) of the substrate 50.

As shown in FIGS. 18-26, the substrate 50 further comprises or defines an attachment member 54 positioned in a center portion of the groove 52. As shown and described further herein, the attachment member 54 may have a variety of different configurations (i.e., an extension 56 or a slot 58) according to the various embodiments and according to the configuration of the locating member 82. As described further herein, the configuration of the locating member 82 and the attachment member 54 correspond to and are complementary to each other such that the locating member 82 and the attachment member 54 are attachable to each other.

To allow the clip 84 (that is the locating member 82 according to one embodiment) to attach to the attachment member 54 (to attach the bracket structure 70 (and the skin 30) to the substrate 50), the attachment member 54 of the substrate 50 is a rib, tongue, or extension 56 within the groove 52 that extends upward from a center or middle region of a top surface of a bottom wall 55 of the groove 52, as shown in FIGS. 18-22. The extension 56 is located along a middle portion of the bottom wall 55 of the groove 52 and extends along the length of the groove 52. The extension 56 may extend along only a portion of the height of the groove 52 (e.g., the height of the side walls 53 of the groove 52) to allow the clip 84 to be fully positioned within the groove 52.

The extension 56 is configured to be received within the channel defined by the clip 84 (i.e., between the two side walls 88 of the clip 84). To attach the clip 84 to the extension 56, the clip 84 (or portions of the clip 84, such as the side walls 88 and/or the teeth 89) may flex or bend to securely fit and extend around width of the extension 56. Once the clip 84 of the bracket structure 70 is attached to extension 56 of the substrate 50 (as shown in FIGS. 31-33), the two side walls 88 and their corresponding teeth 89 are positioned on either side of the extension 56. The clip 84 (specifically the teeth 89) frictionally engages and grips to the side surfaces of the extension 56 of the substrate 50, which locks the clip 84 to the extension 56. Since the teeth 89 are angled upward from the side walls 88, the teeth 89 deter the clip 84 from detaching from the extension 56.

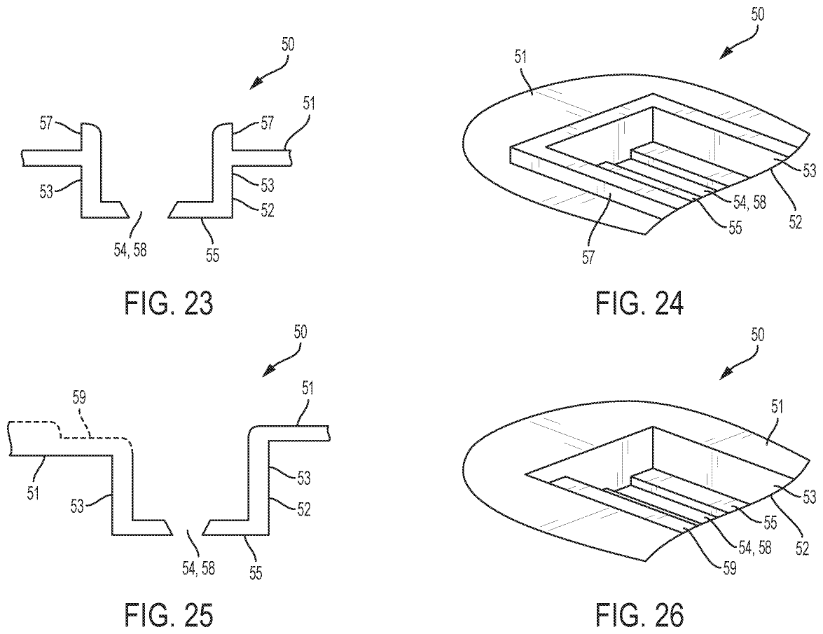

To allow the plug 92 (that is the locating member 82 according to another embodiment) to attach to the attachment member 54 (and thus to attach the bracket structure 70 (and the skin 30) to the substrate 50), the attachment member 54 of the substrate 50 is a hole, aperture, or slot 58 positioned and defined by the bottom wall 55 of the groove 52, as shown in FIGS. 23-26. The slot 58 is located along a middle portion of the bottom wall 55 of the groove 52 and extends widthwise along part of the bottom wall 55 of the groove 52 and extends lengthwise along the length of the groove 52.

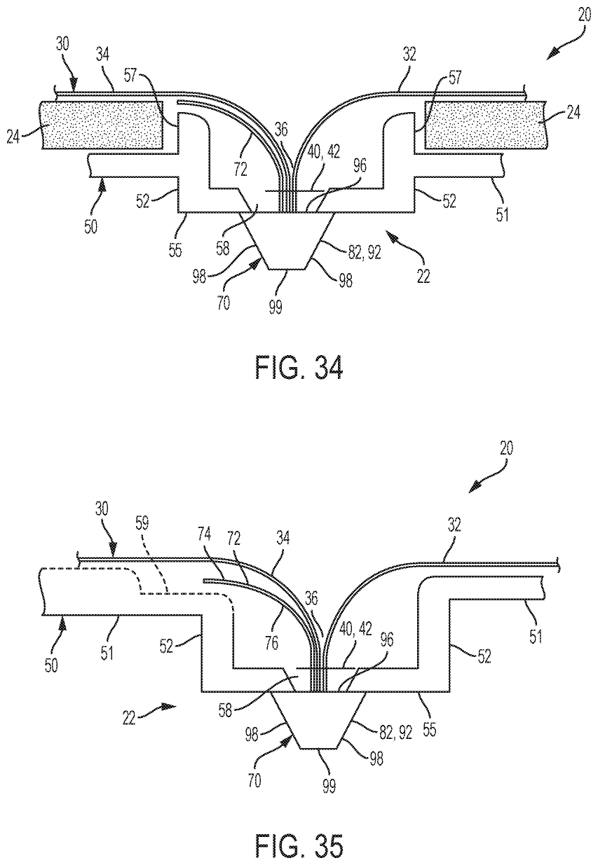

To attach the plug 92 to the slot 58, the plug 92 is force-fit and inserted through the slot 58 and the slot 58 is configured to receive the plug 92 (as shown in FIGS. 34-35), which retains the bracket structure 70 to the substrate 50. The flange 72 extends through the slot 58 when the bracket structure 70 is engaged with and retained by the substrate 50. The width of the slot 58 is smaller than the width along the top wall 96 of the plug 92 such that, once the plug 92 is inserted into and through the slot 58, the top surface of the top wall 96 of the plug 92 and the underside or bottom surface of the bottom wall 55 of the groove 52 abut or engage with each other. Accordingly, the plug 92 (i.e., the locating member 82 of the bracket structure 70) engages the slot 58 (within the groove 52 of the substrate 50) with an interference fit, which keeps the plug 92 from moving back through the slot 58 and thereby retains the bracket structure 70 to the substrate 50.

The ends or edges of the bottom wall 55 that define the slot 58 with sidewalls that may be tapered or angled downward to allow the plug 92 to move more easily into and through the slot 58, while preventing the plug 92 from moving backward out through the slot 58. Accordingly, the length along the bottom surface of the bottom wall 55 of the groove 52 is larger than the length along the top surface of the bottom wall 55 of the groove 52.

By using the plug 92 and the slot 58, the skin attachment assembly 20 saves weight since the attachment member 54 of the substrate 50 is a slot that inherently reduces the amount of require material.

According to one embodiment as shown in FIGS. 32 and 35, the substrate 50 is a support structure that is hard-wrapped and therefore does not include any spacer fabric. According to another embodiment as shown in FIGS. 31, 33, and 34, the top surface of the top wall 51 of the substrate 50 is covered by and soft-wrapped with a spacer fabric 24 (e.g., a foam layer) to create a “soft-wrapped” condition. The spacer fabric 24 is positioned along various areas of the substrate 50 except for within the groove 52, such as along the top surface of portions of the top wall 51 of the substrate 50. To keep the spacer fabric 24 in place along the substrate 50 and since the spacer fabric 24 increases the height of the substrate 50, the substrate 50 may further comprise a rib, flange, collar, or rim 57 that extends upward from the side walls 53 of the groove 52 and above the top surface of the top wall 51 as shown in FIGS. 18-20 and 23-24. The rim 57 may optionally extend around the perimeter of the groove 52, as shown in FIGS. 20 and 24. The top edge of the rim 57 have a rounded or curved corner (as shown in FIG. 18) or may have a straight-edged corner (as shown in FIG. 19).

As shown in FIGS. 31, 33, and 34, the skin 30 extends above and over the rim 57 to allow the skin 30 to clear the spacer fabric 24 without compressing the spacer fabric 24 and to prevent the spacer fabric 24 from moving into the groove 52. The rim 57 may extend sufficiently high above the top wall 51 of the substrate 50 such that the top of the flange 72 is positioned completely within the groove 52, as shown in FIGS. 31 and 33. Alternatively, the rim 57 and/or the side walls 53 may be relatively shorter (or the flange 72 may be relatively longer) such that the flange 72 extends over the top edge of the rim 57 (as shown in FIG. 34). Accordingly, the height of the rim 57 above the top surface of the top wall 51 may be slightly less than the height of the spacer fabric 24 to provide a recessed area for the end of the flange 72 to be bent into to create a smooth-looking outer surface of the skin attachment assembly 20.

The various components of the bracket structure 70 and the substrate 50 can be constructed out of a variety of different materials, including but not limited to plastic and/or metal. For example, the flange 72 and/or the locating member 82 may be constructed out of plastic (e.g., plastic molding) or rubber. According to one embodiment where the locating member 82 is the clip 84, the teeth 89 of the clip 84 may be constructed out of metal while the surrounding side walls 88 of the clip 84 may be constructed out of plastic.

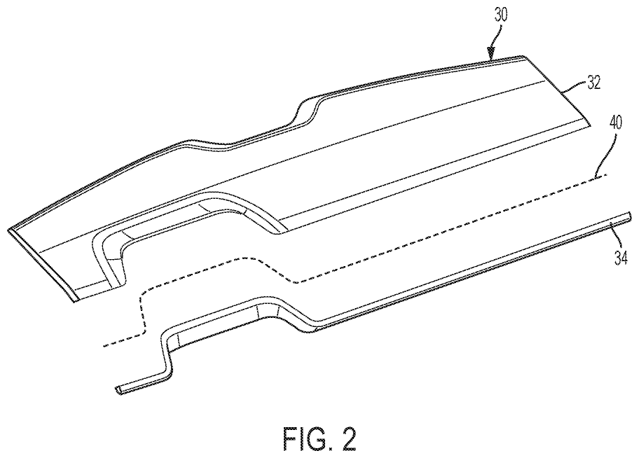

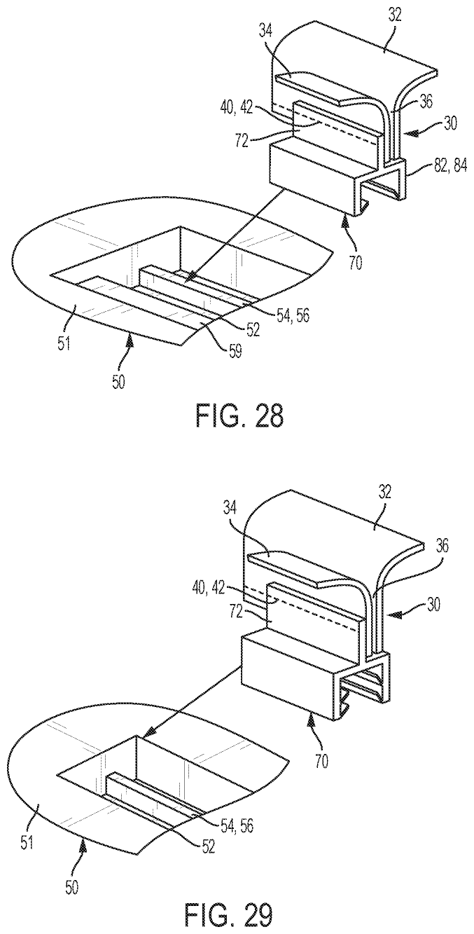

FIGS. 2-35 show the manner in which the skin attachment assembly 20 can be assembled, according to various embodiments. FIG. 2 shows the first skin portion 32 and the second skin portion 34 of the skin 30 prior to attachment to the bracket structure 70 (and the entire retaining structure 22). The first skin portion 32 and the second skin portion 34 will be joined or attached together along the seam line 36 by a functional stitch line 42 (as shown in later figures) formed by the thread 40. FIGS. 3-12 show various configurations of the bracket structure 70 prior to attachment to the skin 30 and the substrate 50.

As shown in FIGS. 13-16, the skin 30 and the bracket structure 70 are first attached to and sewn onto each other with the functional stitch line 42 of the thread 40. To attach the bracket structure 70 and the skin 30, the thread 40 is stitched through the flange 72, the first skin portion 32, and the second skin portion 34, thereby creating the functional stitch line 42 which connects the flange 72, the first skin portion 32, and the second skin portion 34 and forms or secures the seam line 36 of the skin 30. The skin 30 is sewn to the flange 72 along the length of the flange 72 or the skin 30 and along where the seam line 36 of the skin 30 is being formed. Accordingly, the stitch line 42 (made of the thread 40) along the seam line 36 holds the skin 30 and the flange 72 together (and holds the seam line 36 together). By attaching the skin 30 and the bracket structure 70 to each other prior to assembly to the substrate 50 and prior to any final wrapping process, the bracket structure 70 increases the quality of the final product of the skin attachment assembly 20.

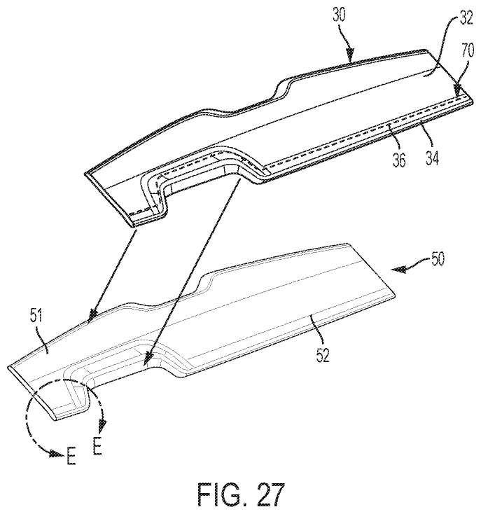

FIGS. 17-26 show the substrate 50 prior to attachment to the bracket structure 70 (and therefore the skin 30). Once the skin 30 and the bracket structure 70 have been attached (e.g., sewn) together, the bracket structure 70 (with the skin 30) can then be located to and subsequently attached to the substrate 50, as shown in FIGS. 27-29. More specifically, the end of the locating member 82 of the bracket structure 70 is located to the top of the groove 52 of the substrate 50.

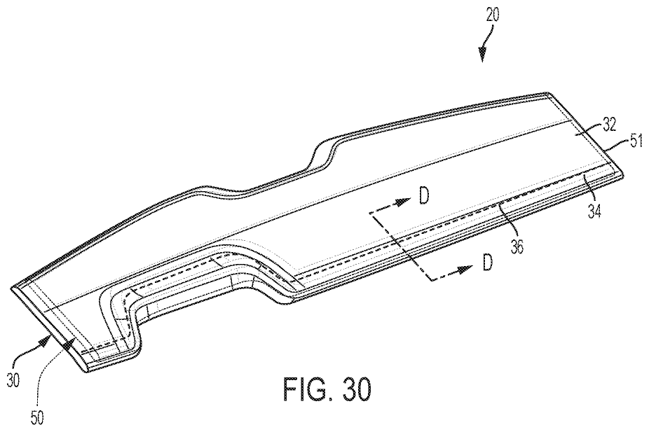

Once the locating member 82 of the bracket structure 70 has been located to and positioned along the groove 52 of the substrate 50, the locating member 82 of the bracket structure 70 (with the skin 30) is then pressed into the groove 52 of the substrate 50, which attaches the bracket structure 70 and the substrate 50, as shown in FIGS. 30-35. Since the bracket structure 70 and the seam line 36 of the skin 30 are sewn and attached together, when the operator presses (and thereby attaches) the bracket structure 70 into the groove 52 of the substrate 50, the operator is also pressing (and thereby also attaching) the seam line 36 of the skin 30 into the groove 52 of the substrate 50.

As the bracket structure 70 is pressed into the groove 52 of the substrate 50, the locating member 82 automatically locates and aligns itself within the groove 52 and subsequently attaches to the attachment member 54 in the groove 52, which retains the bracket structure 70 (and thereby the seam line 36 of the skin 30) within the groove 52 of the substrate 50. The operator can press along the entire length of the seam line 36 to locate and attach the entire locating member 82 to the attachment member 54 of the substrate 50. Once the bracket structure 70 is received within (or positioned inside of) and attached to the groove 52, the flange 72 (which is sewn to the seam line 36 of the skin 30) extends upward from the groove 52 (e.g., away from the bottom wall 55 of the groove 52) and optionally can extend outside of the groove 52.

Once the bracket structure 70 is attached to the substrate 50, the bracket structure 70 may be slid along the length of the groove 52 of the substrate 50 to obtain the optimal relative position between the skin 30 and the substrate 50. Accordingly, the seam line 36 can be positioned in the desired location along the substrate 50.

To cause the flange 72 to bend over into the recess 59 of the substrate 50 (in an embodiment that includes the recess 59, as shown in FIGS. 32 and 35), the skin 30 is first stretched in one direction orthogonal to the length of the bracket structure 70 (and therefore orthogonal to the length of the flange 72) and then connected to an underlying structure to keep the first side of the skin 30 in place and in tension before pulling in the other direction. The skin 30 is then subsequently pulled in a second, opposite direction and connected to an underling structure to keep the second side of the skin 30 in place and in tension. The skin 30 may be first pulled toward the side of the skin 30 that is the shortest distance until that side of the skin 30 is held in place before pulling in the other direction. Alternatively, the skin 30 may be first pulled along the side of the skin 30 that is closer to the recess 59 to ensure that the flange 72 is positioned within the recess 59.

Once the bracket structure 70 and seam line 36 of the skin 30 have been located and fully attached to and positioned along the groove 52 of the substrate 50, the skin 30 and the substrate 50 have a semi-permanent attachment to each other. The operator can then complete the assembly process of completely attaching the skin 30 to the substrate 50 with a final wrapping to create the final assembly without having to otherwise hold or align the skin 30 to the substrate 50. The assembly process may be completed with a variety of different techniques, including but not limited to glue bonding, skin wrapping, and/or stapling while tension is being applied to the skin 30.

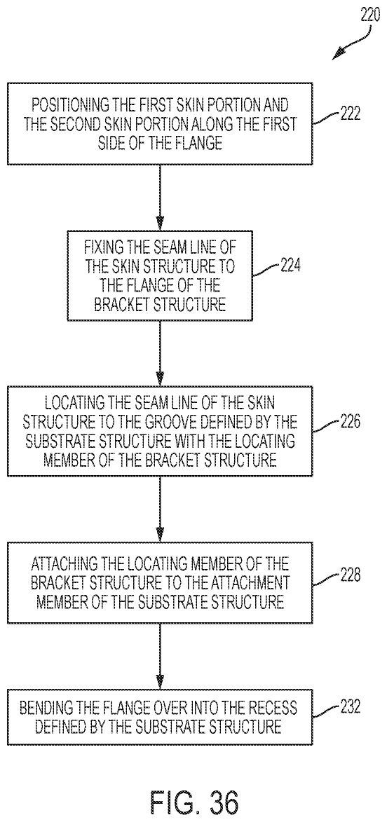

FIG. 36 shows an overview of the method of locating and retaining the skin. More specifically, to locate and retain the skin, the skin attachment assembly 20 is assembled. First, both the first skin portion 32 and the second skin portion 34 are positioned along the first side 74 of the flange 72 (222) prior to fixing the seam line 36 of the skin 30 to the flange 72. Then, the seam line 36 of the skin 30 is fixed to the flange 72 of the bracket structure 70 (224) by, for example, sewing the skin 30 onto the flange 72 with the thread 40, which forms the stitch line 42. Next, the seam line 36 of the skin 30 is located to the groove 52 (that is defined by the substrate 50) with the locating member 82 of the bracket structure 70 (226). Subsequently, the locating member 82 of the bracket structure 70 is attached to the attachment member 54 that is positioned within a center portion of the groove 52 of the substrate 50 (228). Finally, the flange 72 is bent over into the recess 59 that is defined by the substrate 50 and positioned along at least one side of the groove 52 of the substrate 50 (232), which may occur while the skin 30 is being tightened down or wrapped around the substrate 50.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A skin attachment assembly comprising:
a skin comprising a seam line; and
a retaining structure for locating and retaining the skin, the retaining structure comprising:
a bracket structure configured to locate the seam line of the skin to the substrate, the bracket structure comprising a flange and a locating member, the flange configured to be fixed to the seam line of the skin; and
a substrate defining a groove and comprising an attachment member positioned within a center portion of the groove;
wherein the locating member of the bracket structure is configured to attach to the attachment member within the groove of the substrate.

2. The skin attachment assembly of claim 1, wherein the skin comprises a first skin portion on one side of the seam line and a second skin portion of the other side of the seam line, wherein the flange comprises a first side and a second side, wherein both the first skin portion and the second skin portion are positioned along and attached to the first side of the flange.

3. The skin attachment assembly of claim 2, wherein the first skin portion and the second skin portion of the skin are two separate pieces of material that are attached to each other along the seam line with a stitch line.

4. The skin attachment assembly of claim 2, wherein the first skin portion and the second skin portion of the skin are part of a single, continuous sheet of material, wherein the seam line divides the skin into the first skin portion and the second skin portion.

5. The skin attachment assembly of claim 2, wherein the substrate defines a recess positioned along at least one side of the groove, wherein the flange is configured to be received within the recess.

6. The skin attachment assembly of claim 6, wherein the recess is positioned along a side of the groove that is closer to the second side of the flange than the first side of the flange.

7. The skin attachment assembly of claim 6, wherein the recess is positioned along only one side of the groove, wherein the groove extends from a top wall of the substrate and is formed by two side walls and a bottom wall, wherein a curvature between a top surface of the top wall of the substrate and one of the side walls of the groove along the side of the groove that the recess is positioned along is less than a corresponding curvature along the other side of the groove.

8. The skin attachment assembly of claim 1, wherein the attachment member of the substrate is an extension extending upwardly from a top surface of a bottom wall of the groove.

9. The skin attachment assembly of claim 8, wherein the locating member is a clip configured to extend around and grip side surfaces of the extension.

10. The skin attachment assembly of claim 1, wherein the attachment member of the substrate is a slot defined by a bottom wall of the groove.

11. The skin attachment assembly of claim 10, wherein the locating member is a plug configured to be inserted through and retained by the slot.

12. The skin attachment assembly of claim 1, wherein the attachment member is configured to retain the locating member within the groove.

13. The skin attachment assembly of claim 1, wherein the flange extends from a top surface of the locating member.

14. The skin attachment assembly of claim 1, wherein the skin is sewn to the flange along the seam line of the skin.

15. The skin attachment assembly of claim 1, wherein the flange is flexible and configured to bend.

16. The skin attachment assembly of claim 1, wherein the skin and the substrate are attached to each other with only one seam line.

17. The skin attachment assembly of claim 1, wherein the skin is configured to substantially cover the substrate.

18. A method of locating and retaining a skin, the method comprising:
fixing a seam line of a skin to a flange of a bracket structure;
locating the seam line of the skin to a groove defined by a substrate with a locating member of the bracket structure; and
attaching the locating member of the bracket structure to an attachment member positioned within a center portion of the groove of the substrate.

19. The method of claim 18, wherein the skin comprises a first skin portion on one side of the seam line and a second skin portion of the other side of the seam line, wherein the flange comprises a first side and a second side, further comprising positioning both the first skin portion and the second skin portion along the first side of the flange prior to fixing the seam line to the flange.

20. The method of claim 19, further comprising bending the flange over into a recess defined by the substrate and positioned along at least one side of the groove of the substrate.
